(19) United States
(12) Patent Application Publication
(10) Pub. No.: US 2023/0210301 A1
(43) Pub. Date: Jul. 6, 2023

(54) SUPPORT STAND FOR FILLING BEVERAGE CONTAINERS

(71) Applicant: Jack Enkema, Cambridge, MA (US)

(72) Inventor: Jack Enkema, Cambridge, MA (US)

(73) Assignee: Jack Enkema, Cambridge, MA (US)

(21) Appl. No.: 18/086,165

(22) Filed: Dec. 21, 2022

Related U.S. Application Data
(60) Provisional application No. 63/266,484, filed on Jan. 6, 2022.

(51) Int. Cl. A47J 31/44

(52) U.S. Cl. CPC A47J 31/4482; A47J 31/4425

(57) ABSTRACT

The present invention relates generally to support stands for beverage containers. The support stand includes a base that is in contact with a support surface, such as a table. The base is connected to a container support that is configured to securely hold and support a beverage container, for example a thermos or coffee mug. The support stand is configured to support the beverage container at a mostly vertical angle, whether the support stand is manufactured at a fixed angle or whether the support stand is capable of being set at specific angles. The angle of the support stand allows the beverage container to be properly aligned and placed under the dispenser of a drink machine, such as a coffee maker or soda machine. The support stand thus allows for hand-free filling of the beverage container without the need for supervision or the fear of spilling.

### FIELD OF ENDEAVOR

This disclosure relates broadly to support stands for beverage containers and more particularly to angled support stands for coffee mugs, thermoses, glasses, cups, etc.

### BACKGROUND

Millions of people start their day off with a jolt of caffeine, whether it be from coffee, tea, or soda. On the other hand, others start their day off with decaffeinated drinks, such as water or hot chocolate. Either way, morning routines have become ritualistic for the modern workforce. However, everyone can agree that they want their drink-of-choice fast and they want to keep it at the perfect temperature. Modern drink dispensers, such as single-brew coffee makers, have become a household, workplace, and industry commonality to quickly brew a variety of beverages, caffeinated and decaffeinated alike. These drink dispensers allow users to select their preferred beverage, while also providing a drink in a few minutes.

On the other hand, thermoses provide the other half of what every drink enthusiast seeks; namely, a large drink that stays hot or cold for a long time. However, modern drink dispensers are not designed to accommodate the height of many thermoses on the market today. This means that users are required to hold their thermos in place as their drink is brewed. The other option would be to fill a smaller sized cup and transfer the beverage to a larger container or thermos. Instead of getting ready for their day, people are either stuck as their drink is prepared or must brew multiple cups to fill their thermos. While beverages are an integral part of many people's mornings, getting out the door in the morning can be quite stressful. On top of the morning rush, running late can add an undesirable layer of stress to one's day.

Therefore, it is desirable to have a convenient method of holding a thermos or other large beverage container under the spout of a drink dispenser, such as a single-brew coffee maker, so a user can simultaneously make their favorite morning drink and get ready for their day. While this is advantageous, users should be cautious of leaving minors or children in the vicinity of unattended hot (potentially scalding) liquids. This technology may also be implemented in other applications where hands-free drink despising is desirable.

### SUMMARY

Various embodiments of the present disclosure include support stands for beverage containers for use when the selected beverage container or thermos is too tall to fit under the spout of a beverage dispenser, such as a single-brew coffee maker. To ensure the beverage container is filled fully and properly, the support stand holds the beverage container at a mostly vertical angle such that the mouth of the container extends under and aligns with the spout of the beverage dispenser. In certain embodiments, a user may conveniently adjust the angle of the support stand to accommodate various containers or thermoses of various heights, so the container and beverage dispenser are aligned properly. The support stand can be placed and/or locked in an “open” position where the receptacle for the beverage container is supported at a mostly vertical angle relative to the support surface that the support stand rests on.

A user can either place a thermos in the support stand and then set and/or lock the support stand at the appropriate angle or can set and/or lock the support stand at a particular angle and place the thermos on the support stand. In both instances, the mouth of the thermos or beverage container is able to properly align with the spout of the drink dispenser. This allows the user to begin brewing their desired beverage and then walk away. The support stand will support the beverage container as it is being filled and when it is completely filled so a user is not required to supervise the filling process. Proper angling of the beverage container and support stand may be fixed or adjustable before or during use, for example as accomplished by mechanical means or automatic means.

In some embodiments, the support stand may be also be placed and/or locked in a “storage” position, where the receptacle for the beverage container lays parallel against the base of the support stand. This allows for easy, compact storage of the support stand.

Alternatively, in other embodiments, the angle of the support stand may be fixed, so that the support stand sits at an appropriate angle and can be used with a preferred beverage container and coffee maker without adjusting the angle of the stand. Similarly, the support stand will hold the beverage container during and after filling, thus allowing the user to focus on other tasks. The embodiments of the present disclosure are discussed primarily with reference to thermoses and coffee makers, however, it should be appreciated that this technology may be used in association with other beverage containers and drink dispensers. For example, this technology may be implemented in association with cocktail shakers or glasses and soda dispensers (e.g., hoses or soda machines) for hands-free bartending applications. This technology may also have commercial and/or industrial applications for dispensing liquids other than those for human consumption. For example, the devices disclosed herein may be applied in factory settings, such as filling paint cans or household cleaners.

Other objects and attendant advantages will be readily appreciated as the same become better understood by references to the following detailed description when considered in connection with the accompanying drawings.

### BRIEF DESCRIPTION OF THE DRAWINGS

FIG. 1 is a perspective side view of a support stand according to an embodiment of the disclosure.

FIG. 2 is a perspective top view of another support stand according to an embodiment of the disclosure.

FIG. 3 is a side view of the support stand of FIG. 2.

FIG. 4 is a perspective side view of the support stand of FIG. 2 depicted with a thermos.

FIG. 5 is a perspective side view of the support stand of FIG. 4 still depicted with a thermos.

FIG. 6 is a perspective rear view of the support stand of FIG. 4 still depicted with a thermos.

FIG. 7 is a perspective side view of the support stand of FIG. 2 depicted with a coffee mug.

FIG. 8 is a perspective side view of a support stand according to an embodiment of the disclosure.

FIG. 9 is a perspective front view of a support stand according to an embodiment of the disclosure.

FIG. 10 is a perspective side view of a support stand according to an embodiment of the disclosure angled and placed beneath the dispenser of a coffee maker.

FIG. 11 is a side view of the support stand depicted in FIG. 10.

FIG. 12 is a side view of the support stand depicted in FIG. 10 in an alternate configuration.

FIG. 13 is a side view of the support stand depicted in FIG. 12 depicted in yet another alternate configuration.

FIG. 14 is a perspective side view of a support stand according to an embodiment of the disclosure.

FIG. 15 is a zoomed in, perspective side view of the base of a support stand according to an embodiment of the present disclosure.

FIG. 16 is a cross-sectional view of the internal components of the base depicted in FIG. 15.

FIG. 17 is a side view of the base of a support stand according to an embodiment of the disclosure.

### DETAILED DESCRIPTION OF EMBODIMENTS

For the purposes of promoting an understanding of the principles of the disclosure, reference will now be made to the embodiments illustrated and specific language will be used to describe the same. It will nevertheless be understood that no limitation of the scope of the disclosure is thereby intended, such alterations, modifications, and further applications of the principles being contemplated as would normally occur to one skilled in the art to which the invention relates.

Various embodiments of the present disclosure include support stands for beverage containers for use when the selected beverage container is too tall to fit under the spout of a beverage dispenser. For example, when the height of a thermos is taller than the clearance of the spout of a single-brew coffee maker from a support surface. To ensure the beverage container is filled fully and properly, the beverage stand holds the beverage container at a mostly vertical angle such that the mouth of the container extends under and aligns with the spout of the beverage dispenser. As one aspect, a user may conveniently alter the angle of the support stand to accommodate various thermoses or containers of various heights, so the container and beverage dispenser are aligned properly. Alternatively, the angle of the support stand may be fixed, so that the correct support stand sits at an appropriate angle and can be used with a preferred thermos or container without adjustments. Further yet, the support stand may alter the mostly vertical angle automatically by implementing an adjustment mechanism.

A “mostly vertical angle” is an angle that is greater than 45 degrees and less than 90 degrees relative to the support surface.

Directional references herein are for ease of explanation and are not intended to be limiting.

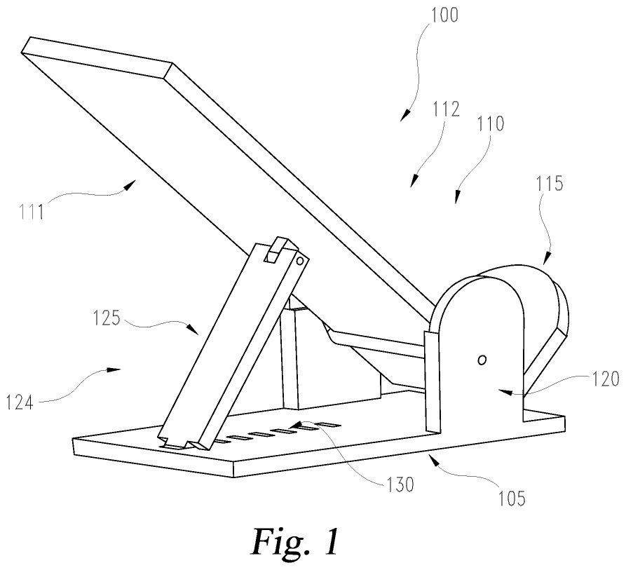

FIG. 1 shows a representative embodiment of a support stand generally designated 100. The support stand 100 is adapted to receive and support various-sized beverage containers. Beverage containers include thermoses, mugs, cups, glasses, and any other container capable of holding or storing liquid.

Support stand 100 includes a base 105 on a support surface for supporting the weight of the support stand 100 and a beverage container. A support surface is any surface that a support stand can rest or sit on, such as a table, countertop, bar top, etc. Support stand 100 additionally includes a container support 110. The container support 110 may include at least one sidewall portion 111 and a floor portion 115. The sidewall portion 111 and floor portion 115 define support cradle 112 which is configured to receive and support the beverage container. In the embodiment shown, the support cradle 112 receives and supports the lower end of the beverage container on the floor portion 115 and receives and supports a sidewall portion of the beverage container on sidewall portion 111. In this manner, the beverage container is supported in both vertical and horizontal directions.

It should be noted that sidewall portion 111 and floor portion 115 may be formed from one continuous piece of material or may be separate pieces connected by an appropriate means, such as welding, melting, adhesives, or any sort of fastener, or combinations thereof. Additionally, in some embodiments, cradle 112 may include rubber gripping to increase the friction between the beverage container and support stand 100. For example, sidewall portion 111 and/or floor portion 115 may be covered by a layer of rubber or rubber strips could be placed along the length and/or width of the sidewall 111 and/or floor 115. Base 105 may optionally have a rubber pad or feet to support base 105 and to provide traction on the support surface. Further, base 105 may be directly connected to or incorporated into the design of a beverage machine.

In FIG. 1, container support 110 is connected to base 105 via a hinge 120, illustrated with opposing side plates and an axle supporting container support 110. Hinge 120 allows the sidewall portion 111 and floor portion 115 to rotate in an angular direction relative to base 105 and allows container support 110/cradle 112 to support a beverage container at a mostly vertical angle. In some embodiments, hinge 120 allows sidewall portion 111 to be positioned perpendicularly relative to base 105 while floor portion 115 is approximately parallel to base 105. This allows support stand 100 to support a beverage container in an upright position, if desired.

It should be appreciated that hinge 120 may be placed at any location sufficient to allow support stand 100 to rotate within a desired range. For example, hinge 120 may be located at a point along sidewall portion 111. Alternatively, hinge 120 may be located where sidewall portion 111 and floor portion 115 connect or the vertex between container support 110 and base 105. As depicted, hinge 120 includes side plates which act as a side walls that prevent the beverage container from moving in a lateral direction and falling off support stand 100 during filling.

Support stand 100 may further include a locking mechanism 124. As depicted in FIG. 1, locking mechanism 124 includes an adjustment lever 125 and a series of notches 130. Adjustment lever 125 is attached to sidewall portion 111 such that adjustment lever 125 supports and/or selectively locks container support 110 at a particular angle when rotated via hinge 120 and engaged with notches 130. More specifically, the adjustment lever 125 serially engages the series of notches 130 to serially hold the container support 110 and beverage container at a particular position in the series of possible positions. Engaging adjustment lever 125 with different notches 130 supports the support stand 100 at different angles, such that various sized beverage container can be used in conjunction with the present disclosure. As will be appreciated with the discussion of various embodiments below, the adjustment lever 125 and notches 130 may be any form suitable to hold and/or lock the support stand 100 at a specific angle. For example, attachment lever 125 may be a metal bar or a metal sheet that engages any number of latches (130) via a biasing spring. In some embodiments, attachment lever 125 may include a rachet mechanism, wherein attachment lever 125 allows support stand 100 to open by subsequently and automatically engaging each of a series of notches 130 while rotating upward while preventing container support 110 from rotating downward until attachment lever 125 is disengaged.

In some embodiments, hinge 120 allows sidewall portion 111 to lay parallel to base 105 while floor portion 115 is approximately perpendicular to base 105. Additionally, adjustment lever 125 may be connected to container support 110 via a hinge such that adjustment lever 125 can be oriented flat against sidewall portion 111. In this manner, adjustment lever 125 and hinge 120 allow for support stand 100 to be adjusted to a storage position.

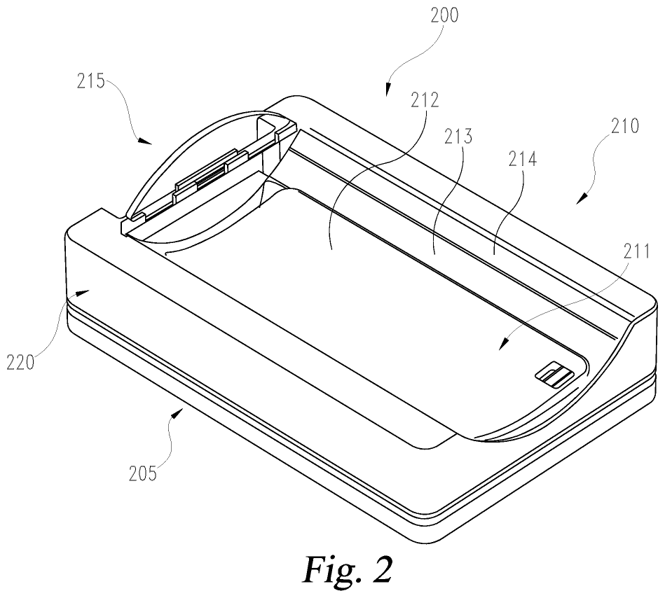

FIG. 2 depicts another embodiment of a support stand 200. In this figure, the support stand 200 is shown in a “storage” position, wherein the container support 210 is folded down and sidewall portion 211 is parallel with base 205. In this manner, adjustment lever 225 (not shown) is also folded and is parallel with base 205 and sidewall portion 211. FIG. 2 further depicts sidewall portion 211 as being concave such that sidewall portion 211 snuggly support a thermos, coffee mug, or other beverage container. Sidewall portion 211 may be of any suitable shape to support various-shaped beverage containers. Alternatively, sidewall 211 may form a 90-degree corner with additional walls extending from sidewall portion 211. Any number of angles or shapes are envisioned as part of the present disclosure. Additionally, sidewall 211 may include a series of concave sidewall sections 213, 214 that define various diameters to support convex beverage containers of various diameters. As shown, sidewall 211 may include a first concave sidewall section 213 for supporting a beverage container of one diameter and a second sidewall section 214 for supporting a beverage container of a second diameter. Similar to the embodiment depicts in FIG. 1, the sidewall portion 211 and floor portion 215 define cradle 212 which supports the beverage container.

Sidewall portion 211 and/or floor portion 215 may also contain rubber pads or strips to increase traction/friction between support stand 200 and beverage container 250.

FIG. 2 additionally depicts hinge 220 positioned near the vertex of base 205 and container support 210. It should be appreciated, however, that hinge 220 can be located at any point along container support 210 to allow adjustment lever 225 to hold and/or lock the support stand at any given angle. In other embodiments, a locking hinge 220 may be used to hold and/or lock container support 210 and beverage container at a mostly vertical angle.

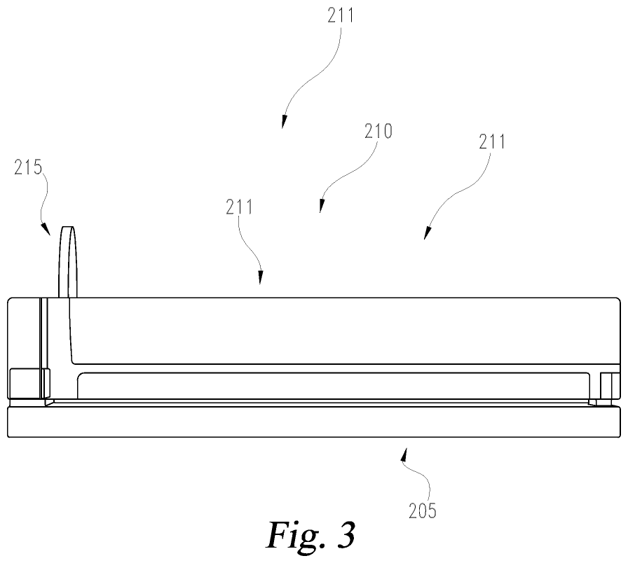

FIG. 3 depicts a side view of the support stand 200 in a “storage” position. The storage position advantageously allows for compact and easy storage of support stand 200. Additionally, floor portion 215 may optionally be foldable, retractable, or otherwise movable so that it is flush or in line with sidewall portion 211, thus further improving the ease of storing support stand 200.

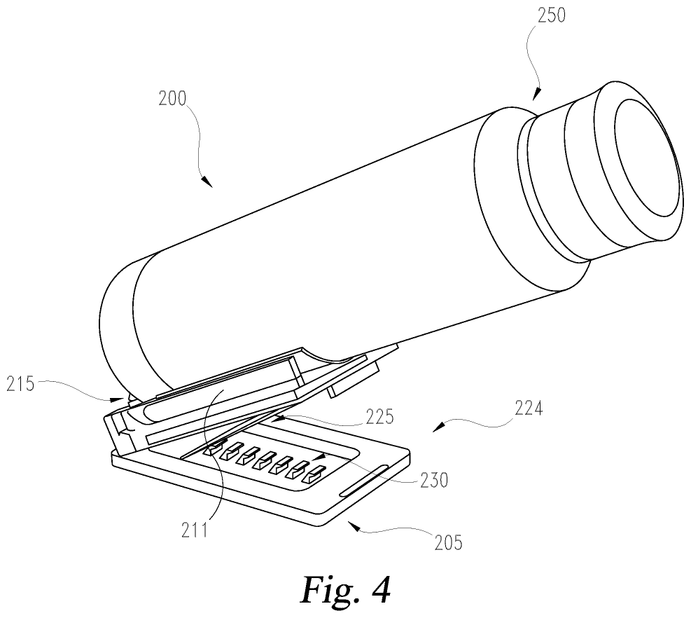

FIG. 4 illustrates support stand 200 in an “open” configuration. Support stand 200 may include locking mechanism 224 which comprises adjustment lever 225 and a series of notches 230. Adjustment lever 225 may be, for instance, a plate or a wire frame. In the open configuration, adjustment lever 225 is engaged with one of the series of notches 230 to hold or lock the support stand 200 at a mostly vertical angle. Adjustment lever 225 may be engaged in different notches 230 to hold a beverage container 250 at different mostly vertical angles. For example, in this embodiment, as adjustment lever 225 is engaged with notches 230 further from hinge 220 (not depicted), the angle between base 205 and container support 210/beverage container increases. This allows a user to adjust the mostly vertical angle at which the beverage container 250 is supported so that the beverage container 250 aligns with the spout of a beverage dispenser. The angle necessary to hold beverage container 250 at the appropriate position relative to the spout of a beverage dispenser depends on the size of the beverage container and the height of the spout from the support surface.

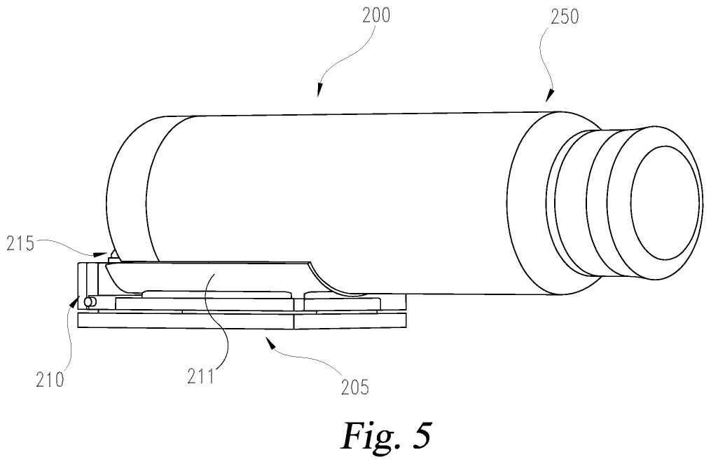

FIG. 5. depicts support stand 200 in a “storage” position while supporting beverage container 250. A user may place an empty beverage container 250 on support stand 200, adjust the angle of the container support 210/beverage container 250 relative to the support surface until the desired angle is reached, then place support stand 200 and beverage container 250 near a beverage dispenser such that the mouth of container 250 extends under and aligns with the spout of the dispenser. Alternatively, a user could open support stand 200 to a desired angle, then place container 250 on container support 210/in cradle 212, then place the support stand 200 and container 250 at the appropriate location for filling. Support stand 200 is configured to support the beverage container 250 at a mostly vertical angle. This allows a user to completely or almost completely fill beverage container 250 with their drink-of-choice.

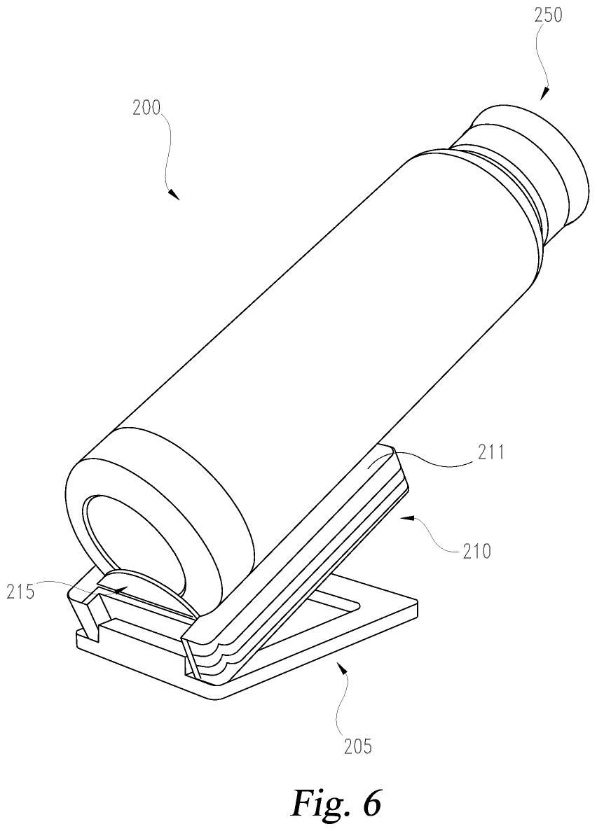

FIG. 6 shows a perspective rear view of support stand 200 and beverage container 250. This illustration shows that sidewall portion 211 supports the side of beverage container 250 while floor portion 215 supports the bottom of beverage container 250. In this manner, beverage container 250 is supported in both vertical and horizontal directions.

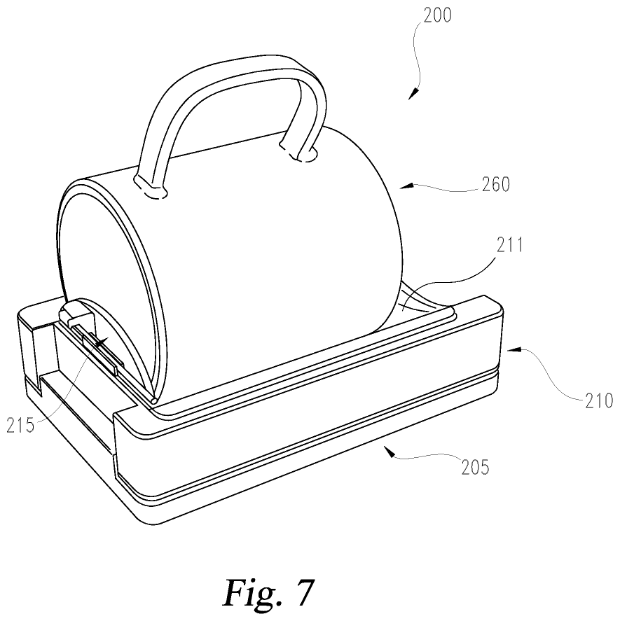

FIG. 7 illustrates the use of a coffee mug 260 in place of beverage container 250. Importantly, support stand 200 is configured to support mugs 260 and containers 250 of various heights, shapes, and diameters.

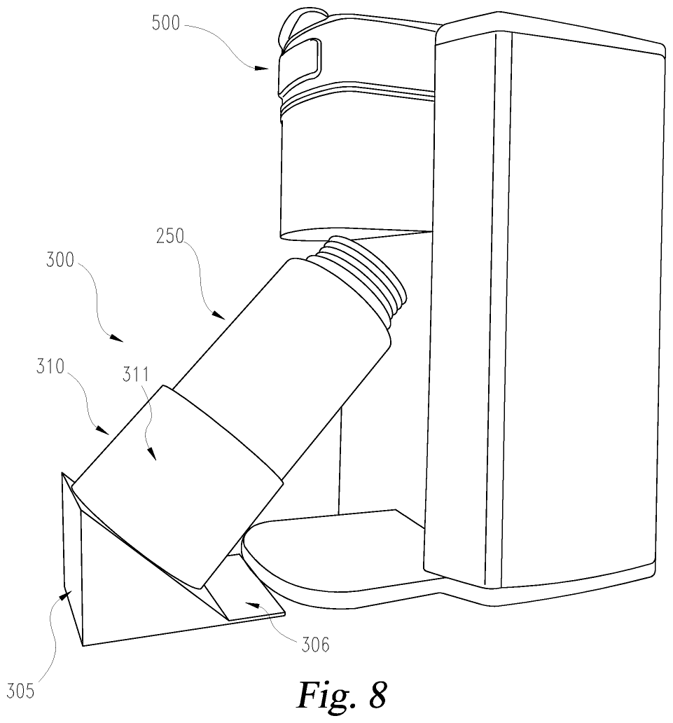

FIG. 8 illustrates an alternative embodiment of the present disclosure. In this embodiment, support stand 300 includes a base 305 and a container support 310. However, container support 310 is permanently affixed to base 305, such that container support 310 is fixed at a mostly vertical angle, as shown. Container support 310 includes one sidewall 311 that is configured as a cylindrical sleeve wherein beverage container 250 can slide into container support 310. However, it should be appreciated that container support 310 may include one or more sidewall portions 311 such that container support 310 can take any shape.

In this manner, support stand 300 holds beverage container at a mostly vertical angle that is fixed. As shown in FIG. 8, support stand 300 and beverage container 250 can be placed under the spout of a single-brew coffee maker 500. This allows a user to place the beverage container 250, start the brewing process of the coffee maker 500, and walk away as the drink is brewed. Further, base 305 may include a plate 306 which helps balance support stand 300 during filling. In some embodiments, plate 306 may be directly connected to or incorporated into the design of a beverage machine.

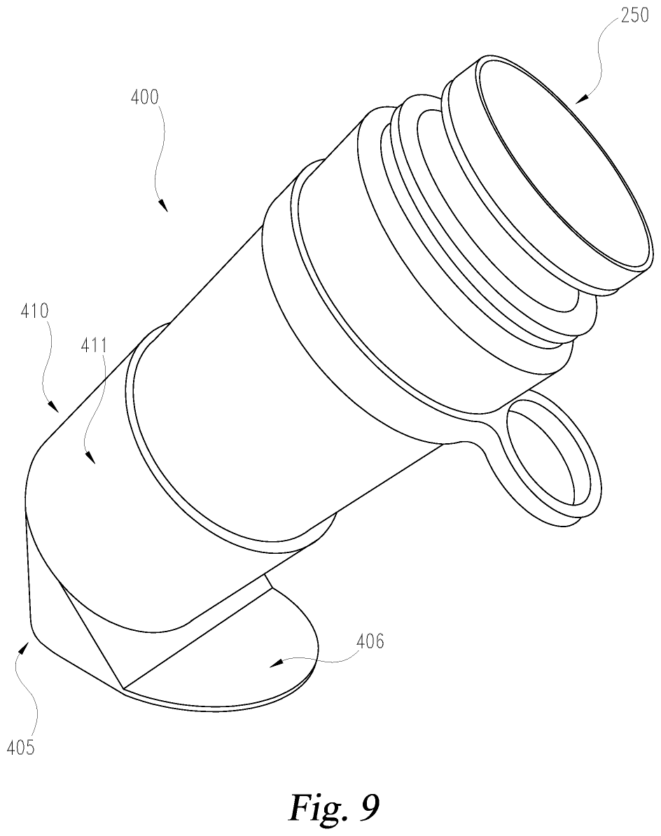

FIG. 9 depicts an alternative design. In this figure, a support stand 400 includes a base 405, container support 410, and sidewall 411 similar to those depicted in FIG. 8, with modifications to the shape of base 405. Importantly, versions of support stands 300, 400 can be manufactured to support beverage container 250 at various fixed angles and support beverage containers 250 of various sizes. For example, support stands 300, 400 can be manufactured with different sized container supports 310, 410 or different angles between container supports 310, 410 and the support surface. This may be accomplished, for example, by manufacturing support stands 300, 400 from molds of various sizes and/or utilizing different specifications in an additive manufacturing process.

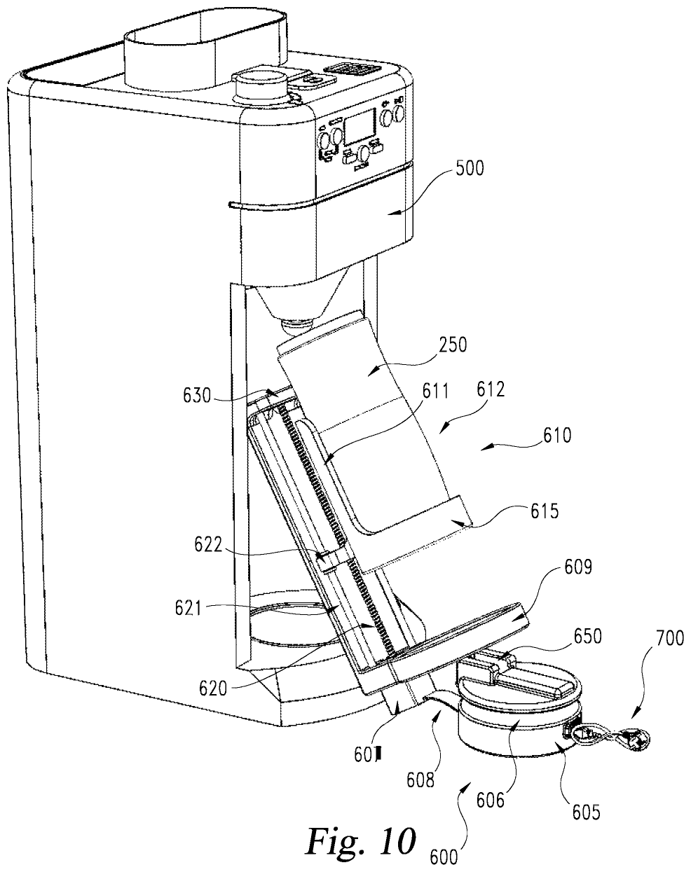

FIG. 10 depicts a perspective side view of a support stand 600 according to an embodiment of the present disclosure. As illustrated, support stand 600 is angled such that beverage container 250 is properly aligned and positioned under the dispenser of coffee maker 500. In situations where the coffee maker 500 includes a check valve, support stand 600 (or 100, 200, 300, or 400) is capable of positioning beverage container 250 relative to the dispenser of coffee maker 500 such that the check valve allows the flow of coffee.

Support stand 600 includes base 605. Base 605 is connected to platform 609/housing 630 via supply box 607 and adjustment mechanism 650. Supply box 607 is configured to provide power to housing 630 via wiring 608 connected to base 605. Base 605 also includes rotating mechanism 606, which is configured to rotate the top portion of base 605, along with platform 609 and housing 630, in an angular direction relative to the supporting surface. Rotating mechanism 606 may be a revolving mechanism, a turntable mechanism, a rotating ring assembly, or a combination of bearings, or any mechanism sufficient to move support stand 600 in an angular direction relative to the supporting surface. Such additional mechanisms will be appreciated by those of skill in the art.

Supply box 607 or base 605 may also house a computer system configured to control automated movement of support stand 600. For example, the system may control the horizontal, vertical, and angular movement of support stand 600. Supply box 607 may also house a motor to drive vertical adjustment mechanism 620 and control motor 654 of adjustment mechanism 650.

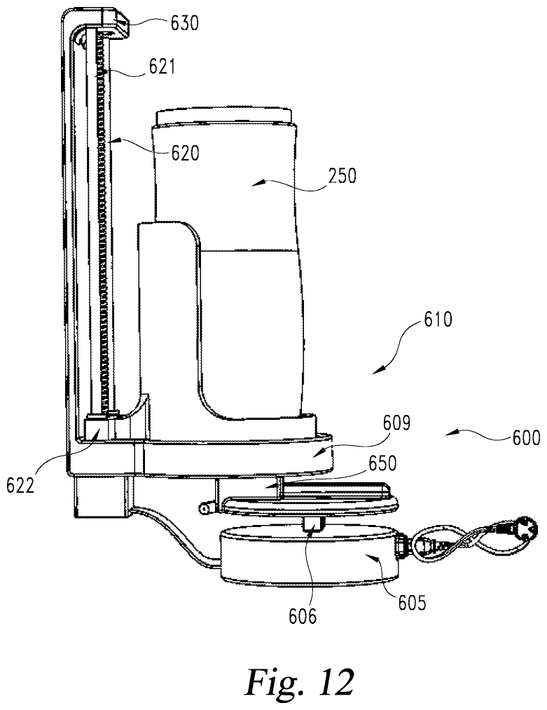

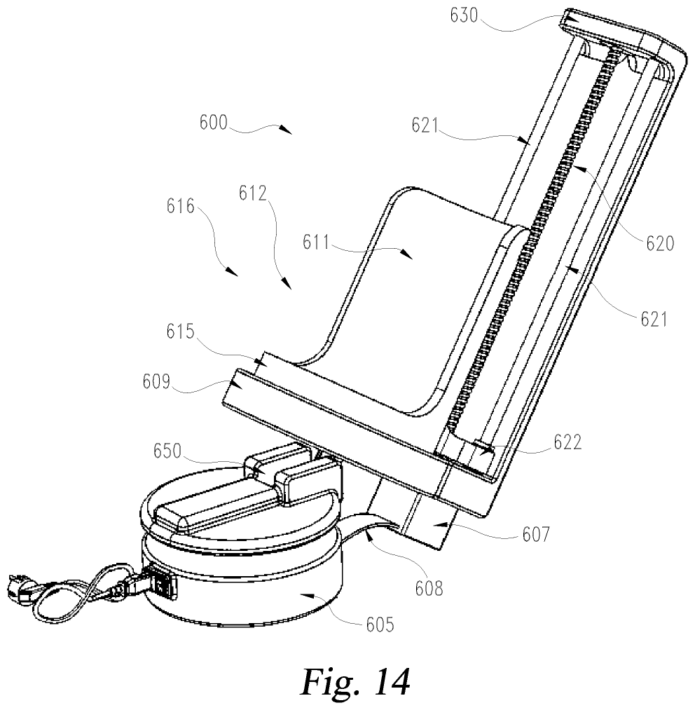

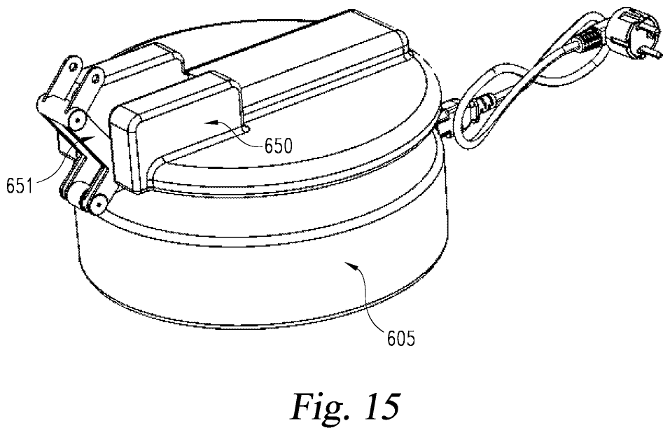

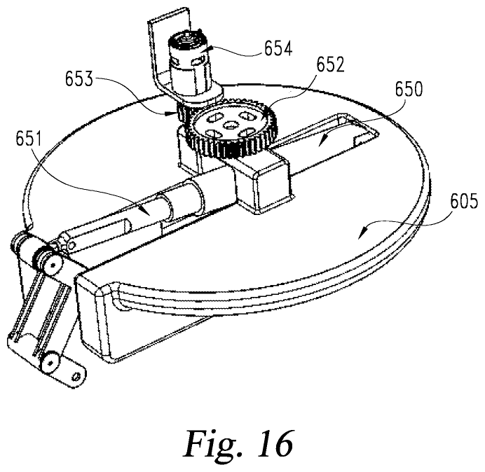

Base 605 includes adjustment mechanism 650 which is connected to platform 609. Adjustment mechanism 650 is configured to move platform 609/housing 630 in a horizontal plane relative to the supporting surface. Movement of adjustment mechanism 650 changes the angle that beverage container 250 is held at, such that support stand 600 can be used in conjunction with various drink dispensers and beverage containers. For example, a comparison of the positioning of platform 609 relative to the supporting surface as depicted in FIGS. 12 and 14 highlights the movement of adjustment mechanism 650. An exemplar mechanism contemplated for adjustment mechanism 650 is discussed in more detail below with reference to FIGS. 15 and 16. However, adjustment mechanism 650 may automatically adjust the mostly vertical angle at which the platform 609/beverage container 250/container support 610 are supported such that they are supported at an angle greater than 45 degrees and less than 90 degrees relative to the support surface. Platform 609/beverage container 250/container support 610 may be supported at a plurality of angles within this range or may be supported at a vertical angle (i.e., 90 degrees).

It should be noted that base 605 may be manufactured of a sufficiently heavy material so that the weight of the base 605 sufficiently offsets the weight of platform 609/housing 630 and the weight of a fully filled beverage container 250. Additionally or alternatively, base 605 may include rubber gripping or temporary attachment means in contact with the support surface that base 605 is placed on. For example, base 605 may include a suction cup configured to temporarily connect support stand 600 to a table. Further yet, base 605 may be connected to or incorporated into the design of beverage machine 500. For example, a plate may be used to connect base 605 to machine 500. Alternative methods of connecting support stand 600 to machine 500 are envisioned.

Base 605 also may include power supply 700. Power supply 700 is configured to supply support stand 600 with power and may be a 2-plug power supply, 3-plug power supply, NEMA power cord, or any cabling sufficient to provide the required power supply to support stand 600. Alternatively, if support stand 600 is connected to a beverage dispensing machine 500, then support stand 600 may receive power supply from the beverage dispenser itself. Similarly, support stands 100, 200, 300, and 400 may be incorporated as a part of the drink dispenser.

Support stand 600 includes platform 609 and housing 630. As shown in FIG. 10, platform 609 and housing 630 may be integrally formed together. In other embodiments, platform 609 and housing 630 may be formed separately and connected by any appropriate means. Housing 630 includes vertical adjustment mechanism 620 and support poles 621. Support stand 600 may include one or more vertical adjustment mechanisms 620 and one or more support poles 621. Vertical adjustment mechanism 620 and support poles 621 are connected to container support 610 via connecting member 622.

Similar to the previously discussed embodiments, container support 610 includes a sidewall portion 611 and a floor portion 615 that define cradle 612. Cradle 612 is configured to receive and support the lower end of a beverage container 250 on the floor portion 615 and receive and support the sidewall portion of beverage container 250 on sidewall portion 211. In this way, container support 610/cradle 612 may support the beverage container 250 at a mostly vertical angel.

As depicted in FIG. 10, vertical adjustment mechanism 620 includes an electrically-driven worm gear, such that clockwise rotation of vertical adjustment mechanism 620 moves container support 610 via connecting member 622 in a first direction relative to platform 609/the support surface. Counter-clockwise rotation, thus, moves container support 610 vertically in a second direction relative to platform 609/the support surface. In this manner, vertical adjustment mechanism 620 controls the height of container support 610/beverage container 250 relative to the support surface. Further, vertical adjustment mechanism 620 may automatically adjust the height of container support 610/beverage container 250.

Therefore, between rotating mechanism 606, adjustment mechanism 650, and vertical adjustment mechanism 620, support stand 600 can move platform 609/beverage container 250 horizontally, vertically, and angularly, relative to the support surface. This may be accomplished manually via mechanical means or automatically via the use of internal electrical systems (discussed in more detail below with reference to FIG. 16).

It should be noted that other vertical positioning mechanisms are included within the scope of the present disclosure. For example, vertical adjustment mechanism 620 and connecting member 622 may include a latch and lock system similar to those depicted with respect to support stands 100 and 200. Alternatively, hydraulic movement of container support 610 may be implemented, just to name a few examples.

Connecting member 622 may include friction-inducing gripping that is in contact with the surface of support poles 621. In this manner, the movement of container support 610 by vertical adjustment mechanism 620 is sufficient to overcome these frictional forces, while at the same time the friction is sufficient to hold container support 610 in place at the desired height.

Housing 630 may also include a sensing element (not shown) configured to locate the dispenser of a beverage machine (e.g., the spout of a coffee maker) and the height of beverage container 250. In this manner, support stand 600 is capable of automatically tilting and lifting beverage container 250 to the appropriate height and angle via adjustment mechanism 650 and vertical adjustment mechanism 620, respectively. Support stand 600 may also be configured to automatically move the beverage container 250 away from the dispenser of the beverage machine after the beverage container 250 is filled. The automatic movement of the support stand 600 may be performed in a number of ways. For example, the container support 610 may include a pressure sensor configured to sense the presence of a container 250 once it is placed on support stand 600. Once the pressure from the container 250 is sensed, the automatic movement of support stand 600 will initiate. In other embodiments, the base 605 may include a button configured to initial automatic movement of support stand 600.

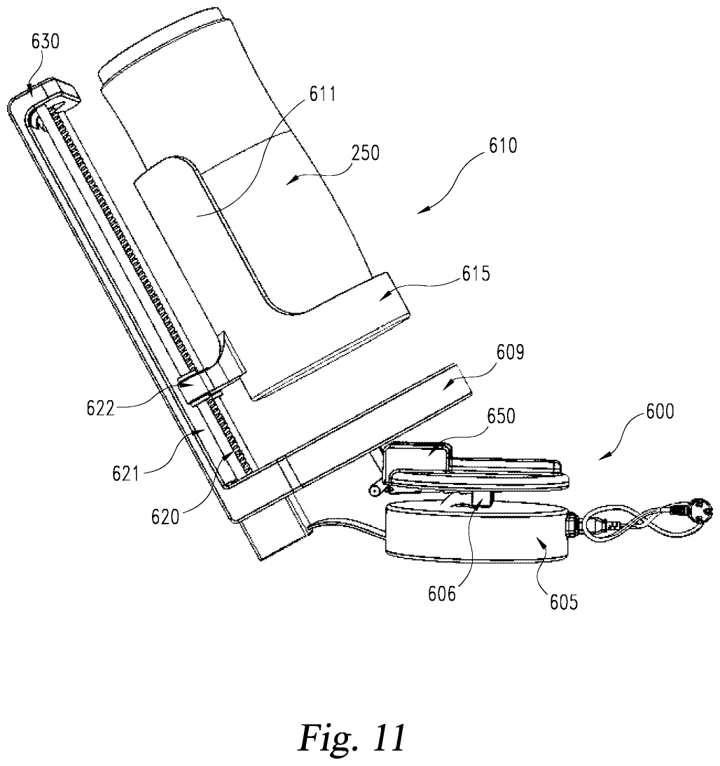

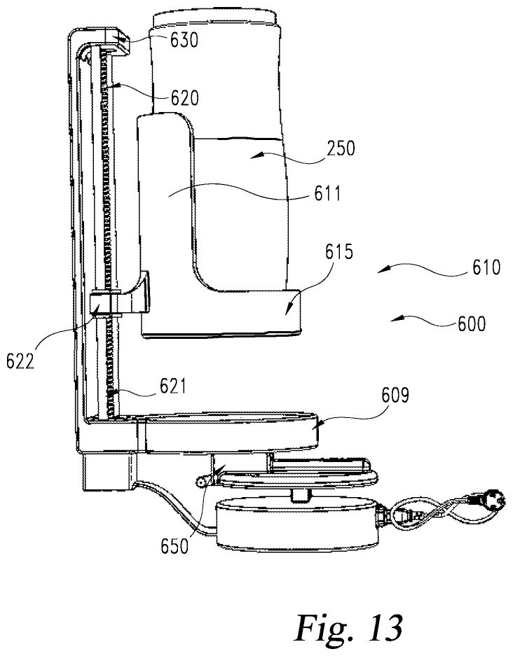

FIGS. 11, 12, and 13 illustrate side views of support stand 600 and display two of the three directions of movement of support stand 600. From FIG. 11 to FIG. 12, beverage container 250 is being moved both vertically via vertical adjustment mechanism 620 and horizontally via adjustment mechanism 650. Further, FIG. 11 displays support stand 600 in one potential configuration while support stand 600 is in use (i.e., beverage container 250 is being filled). On the other hand, FIG. 12 illustrates support stand 600 in an “initial” or “completed” configuration where container support 610 is in contact with platform 609 (i.e., so the beverage container 250 can be placed on support stand 600 before filling or so beverage container 250 can be removed from support stand 600 after filling). FIG. 13 illustrates container support 610/beverage container 250 moving vertically relative to platform 609 independent of the horizontal movement of adjustment mechanism 650. All three directional movements of support stand 600 can be performed either simultaneously or independently.

FIGS. 12 and 13 depict support stand 600 and beverage container 250 in a vertical position. This position is advantageous for a number of reasons. Before the beverage container 250 is filled, the vertical position makes it easier to place container 250 on support stand 600. Similarly, after beverage container 250 is filled, it is easier to remove container 250 from stand 600 from the vertical position. This also eliminates the need for the user to try and remove container 250 from stand 600 while at an angle and placed under the dispenser of a beverage machine, such as a single-brew coffee maker.

FIG. 14 illustrates support stand 600 without beverage container 250. Notable, container support 610 may include sidewall portion 611. As depicted, only one sidewall extends from the base portion of container support 610, which is in the shape of a semi-circle. Notable, any shape container support and associated sidewall(s) 611 are contemplated. Sidewall portion 611 may completely surround beverage container 250 or may have a semi-open configuration, as shown. Further, it is contemplated that rubber pads and/or strips may be used in connection with sidewall portion 611 and/or floor portion 615 to enhance gripping of beverage container 250.

FIG. 15 depicts a close up, perspective view of one exemplar embodiment of base 605 and adjustment mechanism 650. In this embodiment, adjustment mechanism 650 includes a hinge 651. As shown in FIG. 16, hinge 651 includes a telescopic portion. The movement of the telescopic portion of hinge 651 moves the distal end of hinge 651, which alters the horizontal position of platform 609, housing 630, container support 610, and beverage container 250. The telescopic movement of hinge 651 may be a pneumatic piston controlled by electric input, such as a motor. The motor that controls the pneumatic piston may be motor 654 or another motor housed in base 605 or power supply 607.

FIG. 16 also depicts 652 and 653, which are connected in series and receive input from motor 654. The movement of gears 652 and 653 allow the top portion of base 605 to rotate 360° relative to the bottom portion of base 605 via rotating mechanism 606.

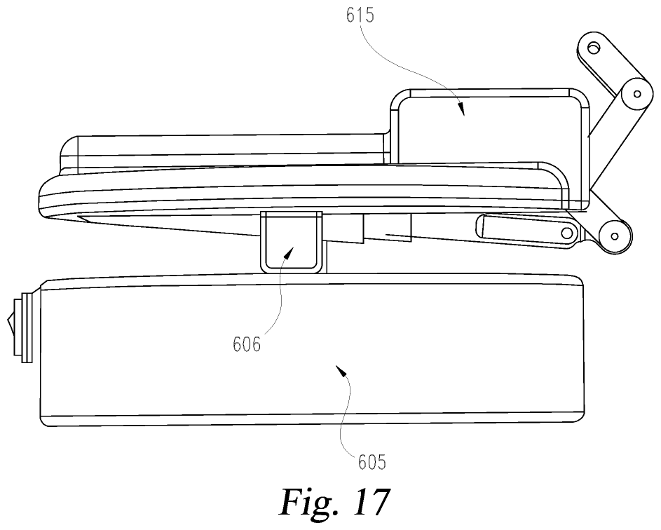

FIG. 17 is a side view of the base 605 illustrated in FIG. 15. From this view, rotating mechanism 606 is shown, which moves the top portion of base 605 360° relative to the bottom portion of base 605.

It will be appreciated by one of skill in the art that this technology may be utilized in a vast array of applications. Support stands 100, 200, 300, 400, and/or 600 may be used with many beverage containers (water cups, soda glasses, rocks glasses, coffee mugs, thermoses, wine glasses, etc.) just to name a few examples. Further, support stands 100, 200, 300, 400, and/or 600 may be used in conjunction with many types of beverage dispensers (coffee makers, single-brew coffee makers, soda dispensers, soda hoses, etc.) just to name a few examples.

While the embodiments have been illustrated and described in detail in the drawings and foregoing description, the same is to be considered as illustrative and not restrictive in character, it being understood that only the preferred embodiments have been shown and described and that all changes and modifications that come with the spirit of the disclosure are desired to be protected.

1. A support stand for a beverage container, comprising:
a base arrangeable on a support surface;
a container support extending from the base, wherein the container support includes a floor portion and at least one sidewall portion together defining a support cradle;
wherein the support cradle is configured to receive and support the lower end of a beverage container on the floor portion and wherein the support cradle is configured to receive and support a sidewall portion of the beverage container on the sidewall portion; and
wherein the support cradle supports the beverage container at a mostly vertical angle such that the beverage container is supported at an angle greater than 45 degrees and less than 90 degrees relative to the support surface.

2. The support stand of claim 1, wherein the support stand supports the beverage container at a mostly vertical angle which is fixed relative to the support surface.

3. The support stand of claim 2, wherein the base and the container support are formed from one piece of material.

4. The support stand of claim 1, wherein the support stand supports the beverage container at a mostly vertical angle which is adjustable relative to the support surface.

5. The support stand of claim 4, wherein the container support is connected to the base via a hinge.

6. The support stand of claim 5, wherein the support stand is adjustable to be supported at a plurality of angles within a range greater than 45 degrees and less than 90 degrees relative to the support surface.

7. The support stand of claim 6, wherein the support stand is adjustable to a storage position wherein the sidewall portion of the container support is parallel to the base.

8. The support stand of claim 1, wherein the beverage container has at least one convexly curved sidewall, and the at least one sidewall portion of the cradle is concave.

9. The support stand of claim 4, wherein the support stand includes an adjustment mechanism which automatically adjusts the mostly vertical angle at which the beverage container is supported relative to the support surface.

10. The support stand of claim 9, wherein the adjustment mechanism automatically adjusts the beverage container to a plurality of angles greater than 45 degrees and less than 90 degrees relative to the support surface.

11. A support stand for a beverage container, comprising:
a base arrangeable on a support surface;
a container support extending from the base, wherein the container support includes a floor portion and at least one sidewall portion together defining a support cradle;
wherein the support cradle is configured to receive and support the lower end of a beverage container on the floor portion and wherein the support cradle is configured to receive and support a sidewall portion of the beverage container on the sidewall portion;
wherein the support cradle supports the beverage container at a mostly vertical angle such that the beverage container is supported at an angle greater than 45 degrees and less than 90 degrees relative to the support surface; and
wherein the angle at which the beverage container is supported is adjustable to a plurality of positions greater than 45 degrees and less than 90 degrees relative to the support surface.

12. The support stand of claim 11, comprising a locking mechanism which selectively holds the support stand in each of the plurality of positions.

13. The support stand of claim 12, wherein the locking mechanism includes a series of notches formed in the base of the support stand and an adjustment lever attached to the container support, wherein said adjustment lever serially engages said series of notches to serially hold the support stand in each position.

14. The support stand of claim 11, wherein the beverage container has a convexly curved sidewall, and the at least one sidewall portion of the cradle is concave.

15. The support stand of claim 14, wherein the concave portion of the sidewall includes a series of concave sidewall sections that define various diameters such that the support stand supports convex beverage containers of various diameters.

16. A support stand for a beverage container, comprising:
a base arrangeable on a support surface;
a container support extending from the base, wherein the container support includes a floor portion and at least one sidewall portion together defining a support cradle;
wherein the support cradle is configured to receive and support the lower end of a beverage container on the floor portion and wherein the support cradle is configured to receive and support a sidewall portion of the beverage container on the sidewall portion;
wherein the support cradle supports the beverage container at a mostly vertical angle such that the beverage container is supported at a position greater than 45 degrees and less than 90 degrees relative to the support surface; and
wherein the support stand includes an adjustment mechanism which automatically adjusts the beverage container to a plurality of positions greater than 45 degrees and less than 90 degrees relative to the support surface.

17. The support stand of claim 16, wherein the adjustment mechanism comprises a hinge driven by an electric motor which automatically adjusts the beverage container to the plurality of positions greater than 45 degrees and less than 90 degrees relative to the support surface.

18. The support stand of claim 16, comprising a vertical adjustment mechanism which automatically adjusts the beverage container to a plurality of heights relative to the support surface.

19. The support stand of claim 18, wherein the vertical adjustment mechanism comprises a worm gear driven by an electric motor which moves the beverage container away from the support surface when rotating in a first direction and moves the beverage container towards the support surface when rotating in a second direction.

20. The support stand of claim 16, wherein the base includes a plate which couples the support stand to a beverage machine.
